(19) United States
(12) Patent Application Publication
(10) Pub. No.: US 2013/0265776 A1
(43) Pub. Date: Oct. 10, 2013

(54) METHOD FOR PRODUCING MOULDED OPTICAL PARTS

(71) Applicants: Olaf Zöllner, Leverkusen (DE); Christoph Klinkenberg, Koln (DE); Christoph Hermansen, Kotzen (DE); Manfred Botzen, Krefeld (DE)

(72) Inventors: Olaf Zöllner, Leverkusen (DE); Christoph Klinkenberg, Koln (DE); Christoph Hermansen, Kotzen (DE); Manfred Botzen, Krefeld (DE)

(73) Assignee: Bayer Intellectual Property GmbH, Monheim (DE)

(21) Appl. No.: 13/989,489

(22) PCT Filed: Nov. 24, 2011
(86) PCT No.: PCT/EP11/70947

§ 371 Date: Jun. 18, 2013

(30) Foreign Application Priority Data
Nov. 24, 2010 (EP) 10192422.3

(51) Int. Cl. B29D 11/00; F21V 5/04

(52) U.S. Cl. CPC B29D 11/00009; B29D 11/00; F21V 5/04
USPC 362/311.02; 264/1.7; 362/335

(57) ABSTRACT

The invention relates to a method for producing an optical moulded body (2), in particular a lens element (2), comprising producing a pre-moulding (4) in a moulding tool by injection moulding of a first plastics material and producing at least one covering layer (6.1, 6.2) on the pre-moulding (4) by injection moulding of a second plastics material, wherein the temperature of the moulding tool for producing the pre-moulding (4) is from 30% to 60% lower than the temperature of the moulding tool for producing the at least one covering layer (6.1, 6.2).

The invention relates to a method for producing optical moulded bodies, in particular optical lenses, wherein a pre-moulding is produced in a moulding tool by injection moulding of a first thermoplastic plastic, and at least one covering layer is produced on the pre-moulding by injection moulding of a second thermoplastic plastic. The invention relates additionally to a moulded body produced by the method according to the invention, and to the use of the moulded body.

Moulded bodies of optical quality are relevant for a large number of applications. For example, optical lenses are used inter alia for light guiding in lighting systems. These include, in addition to motor vehicle headlamps, also lighting devices in the household sector as well as in public spaces, such as, for example, street lighting. Light-emitting diodes (LEDs), which are low-UV and low-IR, are increasingly being used as light sources.

Furthermore, lenses of good optical quality are also required for visual aids, such as spectacles or contact lenses, and for optical devices, such as microscopes, binoculars or telescopes.

Examples of optical moulded bodies are already known from the prior art. For example, DE 102008034153 A1 discloses a method for producing an optical moulded body from a plastics material, wherein the production of the optical moulded body comprises at least three successive injection moulding operations.

DE 69725535 T2 discloses a method for producing plastics products for optical purposes, wherein a primary moulding is first produced from a resin, to which a layer of the same resin is applied to form a secondary moulding. The resin that is intended for covering the primary moulding is heated to a temperature between the recommended lowest temperature of the injection moulding plus 5° C. and the recommended highest temperature minus 5° C. and is injection moulded onto the primary moulding so that, within the temperature range, the primary moulding and the secondary moulding are fused together by melting without subsequent shrinkage.

DD 298620 A5 describes a two-stage injection moulding process for plastics mouldings with the aid of an injection moulding tool, the faces of which that delimit the moulding are displaceable in parallel.

JP 2001-191365 A describes a method for injection moulding thick-walled lenses in which the lens is built up gradually in several layers. The lenses so produced can be produced with a reduced cycle time and exhibit reduced shrinkage.

Furthermore, it has already been described in the literature that, during injection moulding, a high temperature of the moulding tool should be set during the injection phase and a low temperature should be set in the cooling phase. The corresponding tempering process is also referred to as variothermal tempering and has been disclosed inter alia in US 2004/0188886 A1.

DE 69411728 T2 describes a method for producing layered photochromic spectacle lenses, in which, before the thermoplastic plastic is injected, the tool forms used are heated to a temperature that is slightly above the glass transition temperature of the thermoplastic.

DE 20022726 U1 discloses a tool of an injection compression moulding machine for the production of implantable lenses of plastics material, with which it is possible to produce mouldings which, even without mechanical finishing, exhibit very small shape deviations and a very high surface quality while at the same time being free of stresses. It is noted that the mould cavity, on injection of the plastics material, must be kept at a sufficiently high temperature in order to be able to achieve good optical qualities.

US 20090283926 A1 describes a method for laminating a functional film onto an injection-moulded thermoplastic lens in an injection moulding machine. When polycarbonate is used as the thermoplastic for the lens body, the thermoplastic is injected at a melt temperature between 260° C. and 315.6° C. and a tool temperature between 93.3° C. and 146.1° C.

U.S. Pat. No. 7,615,176 claims a method for improving the adhesion within multi-layer composites using two mould cavities, the first mould cavity being kept at a higher temperature than the second mould cavity.

In the prior art, an optimum tool temperature is generally set in order to produce the different layers from a thermoplastic. The prevailing view in the prior art is that an optical moulded body of good quality can only be produced at a substantially optimum tool temperature for each layer. The optimum temperature of the moulding tool depends on the plastics material used and in particular on the glass transition temperature of the plastics material. In the case of polycarbonate, the optimum temperature for thick-walled optical components is, for example, approximately 120° C. (approximately 20° C. to 30° C. below the glass transition temperature of polycarbonate).

However, the optimum tool temperature of 120° brings disadvantages with it. For example, owing to the high tool temperatures, long cooling times of up to 20 minutes per moulded body arise, even in a variothermal method.

Accordingly, the object underlying the present invention is to provide a method for producing an optical moulded body which yields optical moulded bodies having excellent optical quality with, in particular, improved optical imaging characteristics and low internal stresses.

The object set out and indicated above is achieved according to a first aspect of the invention in a method for producing an optical moulded body according to patent claim 1. The method for producing an optical moulded body comprises:
producing a pre-moulding in a moulding tool by injection moulding of a first plastics material,
producing at least one covering layer on the pre-moulding by injection moulding of a second plastics material,
wherein the temperature of the moulding tool for producing the pre-moulding is from 30% to 60% lower than the temperature of the moulding tool for producing the at least one covering layer.

In contrast to the prior art, the internal stress of an optical moulded body made of a transparent thermoplastic is reduced according to the teaching of the invention in that the pre-moulding is produced not at an almost optimum tool temperature but at a significantly lower tool temperature. In addition, as a result of the significantly lower tool temperature, the production time of optical moulded bodies can be reduced significantly owing to the shorter cooling time.

In a first step, a pre-moulding, or a first layer, is produced from a transparent thermoplastic. In contrast to the prior art, however, it is produced not at the optimum tool temperature but at a significantly lower temperature. Preferably, the tool temperature, that is to say the tool wall temperature, can be from 30% to 60% lower than an (almost) optimum tool temperature at which the at least one covering layer is produced.

It has been found according to the invention that, surprisingly, it is sufficient, in order to obtain a high-quality optical component, to produce the at least one covering layer at an (almost) optimum tool temperature, while a pre-moulding can be produced at a significantly lower tool temperature.

For example, two covering layers can be injection moulded, for example in succession, onto opposite surfaces of the pre-moulding. It is also possible subsequently to injection mould a second or third covering layer onto the first covering layer. According to a first preferred embodiment of the method according to the invention, an upper covering layer and a lower covering layer can be applied to the pre-moulding by simultaneous injection moulding of the covering layers. Simultaneous injection moulding means in particular that the two covering layers can be produced at the same time and in the same manner. It has been shown that the internal stresses can be reduced by the simultaneous injection moulding of an upper covering layer and a lower covering layer. At the same time, both surfaces of the pre-moulding can be provided with the injection moulding compound. Better optical properties and, in particular, good surface shaping can be achieved.

According to a further embodiment, the first plastics material can be formed of the same material as the second plastics material. An optical component can thereby be produced in a simple manner. A complex tool that permits injection moulding with at least two different plastics materials is not required. Optical moulded bodies can be formed in a simple manner and with a particularly short cooling time.

Alternatively, the first plastics material can be formed of a different material than the second plastics material. By using different types of plastics material, the advantages of two different plastics materials can be utilised jointly. For example, in the case of optical structural elements that are to be used for outside lighting, it is possible to use for the at least one covering layer a plastics material that is more resistant to environmental influences than the plastics material for the pre-moulding and/or a further covering layer. For example, there can be used for a covering layer poly- or copoly-methyl methacrylates, such as PMMA, which provides improved UV protection, while polycarbonate can be used for the pre-moulding. It is also conceivable to make use of the different refractive indices of different types of plastics materials. For example, an optical moulded body having a covering layer of a plastics material that has a first refractive index that differs from the refractive index of the plastics material of the pre-moulding can be chosen so that a specific light guiding is achieved. An optical moulded body with special functions and/or properties can be created.

According to a preferred embodiment of the method according to the invention, the plastics material can be a transparent thermoplastic plastic, in particular polycarbonate.

Examples of thermoplastic plastics which can be used in the production of the optical moulded bodies are, in addition to polycarbonate (such as Makrolon®), copolycarbonate, polyester carbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), polyamide, cyclic polyolefin, poly- or poly- or copoly-acrylates and poly- or copoly-methacrylate such as, for example, poly- or copoly-methyl methacrylates (such as PMMA) as well as copolymers with styrene, such as, for example, transparent polystyrene acrylonitrile (PSAN), thermoplastic polyurethanes, polymers based on cyclic olefins (e.g. TOPAS®, a commercial product of Ticona), polymethyl methacrylate, or mixtures of the mentioned components. Further materials which can be used are so-called liquid silicone rubber (LSR), for example from Momentive.

Mixtures of a plurality of thermoplastic polymers are also possible, in particular when they can be mixed with one another to give a transparent mixture, preference being given in a specific embodiment to a mixture of polycarbonate with PMMA (more preferably with PMMA <2 wt. %) or polyester.

A further specific embodiment can comprise in this connection a mixture of polycarbonate and PMMA in an amount of less than 2.0 wt. %, preferably less than 1.0 wt. %, more preferably less than 0.5 wt. %, wherein at least 0.01 wt. % PMMA is present, based on the amount of polycarbonate, the PMMA preferably having a molar weight <40,000 g/mol. In a particularly preferred embodiment, the amount of PMMA is 0.2 wt. % and particularly preferably 0.1 wt. %, based on the amount of polycarbonate, the PMMA preferably having a molar weight <40,000 g/mol.

An alternative further specific embodiment can comprise a mixture of PMMA and polycarbonate in an amount of less than 2 wt. %, preferably less than 1 wt. %, more preferably less than 0.5 wt. %, wherein at least 0.01 wt. % polycarbonate, based on the amount of PMMA, is present.

In a particularly preferred embodiment, the amount of polycarbonate can be 0.2 wt. % and particularly preferably 0.1 wt. %, based on the amount of PMMA.

Suitable polycarbonates for the preparation of the plastics composition according to the invention are all known polycarbonates. They are homopolycarbonates, copolycarbonates and thermoplastic polyester carbonates.

The preparation of the polycarbonates takes place preferably by the interfacial process or the melt transesterification process.

Regarding the interfacial process, reference may be made, for example, to H. Schnell, “Chemistry and Physics of Polycarbonates”, Polymer Reviews, Vol. 9, Interscience Publishers, New York 1964 p. 33 ff, to Polymer Reviews, Vol. 10, “Condensation Polymers by Interfacial and Solution Methods”, Paul W. Morgan, Interscience Publishers, New York 1965, Chap. VIII, p. 325, to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145, and to EP 0 517 044 A1.

The melt transesterification process is described, for example, in the Encyclopedia of Polymer Science, Vol. 10 (1969), Chemistry and Physics of Polycarbonates, Polymer Reviews, H. Schnell, Vol. 9, John Wiley and Sons, Inc. (1964) and in patent specifications DE-B 10 31 512 and U.S. Pat. No. 6,228,973.

The polycarbonates are preferably prepared by reactions of bisphenol compounds with carbonic acid compounds, in particular phosgene or, in the case of the melt transesterification process, diphenyl carbonate or dimethyl carbonate.

Particular preference is given to homopolycarbonates based on bisphenol A and to copolycarbonates based on the monomers bisphenol A and 1,1-bis-(4-hydroxyphenyl)-3,3,5-trimethylcyclohexane.

These and further bisphenol or diol compounds which can be used for the polycarbonate synthesis are disclosed inter alia in WO 2008037364 A1 (p. 7, 1.21 to p. 10, 1.5), EP 1 582 549 A1 ([0018] to [0034]), WO 2002026862 A1 (p. 2, 1.20 to p. 5, 1.14), WO 2005113639 A1 (p. 2, 1.1 to p. 7, 1.20).

The polycarbonates can be linear or branched. Mixtures of branched and unbranched polycarbonates can also be used.

Suitable branching agents for polycarbonates are known from the literature and described, for example, in patent specifications U.S. Pat. No. 4,185,009 and DE 25 00 092 A1 (3,3-bis-(4-hydroxyaryl-oxindoles according to the invention, see in each case the whole document), DE 42 40 313 A1 (see p. 3, 1.33 to 55), DE 19 943 642 A1 (see p. 5, 1.25 to 34) and U.S. Pat. No. 5,367,044 and literature cited therein. In addition, the polycarbonates used can also be intrinsically branched, in which case no branching agent is added within the context of the polycarbonate preparation. An example of intrinsic branching is so-called Fries structures, as are disclosed for melt polycarbonates in EP 1 506 249 A1.

Chain tenuinators can additionally be used in the polycarbonate preparation. Phenols such as phenol, alkyiphenols such as cresol and 4-tert-butylphenol, chlorophenol, bromophenol, cumylphenol or mixtures thereof are preferably used as chain terminators. The polycarbonates can additionally comprise polymer additives, such as, for example, flow improvers, heat stabilisers, demoulding agents or processing aids.

UV absorbers or IR absorbers can further be present. Suitable UV absorbers are, for example, described in EP 1 308 084 A1, in DE 102007011069 A1 and in DE 10311063 A1. Suitable IR absorbers are disclosed, for example, in EP 1 559 743 A1, EP 1 865 027 A1, DE 10022037 A1, DE 10006208 A1 and in Italian patent applications RM2010A000225, RM2010A000227 and RM2010A000228.

Of the IR absorbers, preference is given to those based on boride and tungsten and also to ITO- and ATO-based absorbers and combinations thereof.

In a particularly preferred embodiment of the present invention, the thermoplastic plastic can be a polycarbonate having a molecular weight Mw of from 20,000 to 32,000, more preferably from 22,000 to 27,000, determined by gel permeation chromatography with polycarbonate calibration.

In the optical moulded bodies according to the invention, the respective layers can all consist of one thermoplastic plastic or of one mixture of thermoplastic plastics. Alternatively, the layers can also be composed of different thermoplastic plastics or of different mixtures of thermoplastic plastics. The use of one thermoplastic plastic or of one mixture of thermoplastic plastics for all the layers of the optical moulded body is, however, preferred within the context of the present invention.

According to a preferred embodiment of the method according to the invention, the temperature of the moulding tool for producing the pre-moulding can be from 50° C. to 100° C., preferably from 60° C. to 80° C., particularly preferably approximately 70°. In the case of polycarbonate in particular, higher tool temperatures in the (optimum) region of approximately 120° C. (approximately 20° C. to 30° C. below the glass transition temperature of polycarbonate) are set in conventional injection moulding processes. Lower moulding tool temperatures have the advantage over the conventional moulding tool temperature that the cooling time of the optical moulded body can be reduced. The production time can be reduced, and the operational throughput can thereby be improved. At the same time, high-quality optical lenses can be produced. The reason therefor is that the tool temperature on production of the post-moulding is higher and in particular is in the region of the optimum tool temperature. According to a preferred embodiment, the temperature of the moulding tool for producing the at least one covering layer can be from 90° C. to 130° C., preferably approximately 120° C. In particular at a moulding tool temperature of 120° C., high component quality can be ensured owing to that tool wall temperature.

Particularly good results can be obtained when the tool temperature during the production of the pre-moulding of polycarbonate is substantially 70° C. and the tool temperature during the (simultaneous) production of an upper and a lower covering layer of polycarbonate is substantially 120° C.

It is possible in particular to make good and in particular eliminate unevenness or defects in the surface of the pre-moulding owing to the application of the at least one covering layer by injection moulding at an increased and in particular optimum tool temperature.

It has further been found that, in contrast to the prior art, the pressure generated in the moulding tool, that is to say the after-pressure, during the production of the pre-moulding can be reduced significantly without the quality of the end product being impaired. In order to avoid shrinkage holes and similar defects, a pressure of at least 800 bar is generated in conventional injection moulding processes for producing a layer of polycarbonate. According to a further preferred embodiment of the method according to the invention, a pressure of from 250 bar to 800 bar, preferably from 350 bar to 800 bar, particularly preferably from 350 bar to 500 bar, can be generated in the moulding tool during the production of the pre-moulding. As a result of a lower pressure, the internal stresses can be reduced still further. Better optical properties can be achieved. In addition, a low pressure can lead to less stress on the moulding tool.

According to a further preferred embodiment, a pressure of from 800 to 1000 bar can be generated in the moulding tool during the production of the at least one covering layer. It can thereby be ensured that the surface of the optical moulded body has virtually no sink marks.

In addition, according to another embodiment, the layer thickness ratio between the pre-moulding and the covering layers can be from 60:40 to 70:30. In contrast to the prior art, in which the ratio of the pre-moulding to the covering layers is always 50:50 (in the case of three layers 25%-50%-25%), it has been found according to the invention that a pre-moulding having a layer thickness that is significantly greater than the layer thickness of the covering layers can be produced. The layer thickness ratio can depend in particular on process parameters which can be optimised in terms of specific properties. For example, the layer thickness ratio can be chosen in dependence on the (purposively) chosen temperature profile in the cross-section of the finished part as a whole at the time of demoulding, on the (purposively) chosen temperature profile in the cross-section of the component as a whole at the time of overmoulding of the pre-moulding, on the (purposively) chosen temperature profile in the cross-section of the pre-moulding at the time of demoulding of the pre-moulding, on the (purposively) chosen temperature profile in the cross-section of the pre-moulding at the end of the injection of the compound of the pre-moulding, on the different plastics materials that are used both for the pre-moulding and for the covering layers, and/or on the required component qualities in terms of geometric fidelity and internal properties of the finished part. The above-mentioned temperature profiles in the component can be influenced by the melt temperature of the injected plastics material, the tool wall temperatures and/or the residence times (cooling times) in the closed tool both of the pre-moulding and of the covering layers.

In particular, owing to the lower tool temperature, the pre-moulding can have a greater layer thickness without the cooling time for the optical component being increased. This brings the advantage that the layer thickness of the at least one covering layer can be reduced. Reduced layer thicknesses can lead to better surface properties. An optical moulded body having better surface properties can be produced with the same cooling time.

In principle, where there are two covering layers, the layer thicknesses of the two covering layers can be different. According to a preferred embodiment, the layer thickness of the upper covering layer can correspond substantially to the layer thickness of the lower covering layer. More uniform cooling of the optical component is possible. Lower internal stresses occur.

In addition, according to a further embodiment, an optical moulded body having a thickness of at least 10 mm can be produced. It is possible in particular to produce (thick-walled) optical moulded bodies of from 10 mm to 40 mm, for example 20 mm or 30 mm.

According to a further embodiment, an optimum moulding tool temperature (approximately 120° C.) can be set during the injection operation for the production of the at least one covering layer, and the moulding tool temperature can then be cooled, for example by water cooling. The cooling time and accordingly the production time can be reduced.

A further aspect of the invention is a method for producing an optical moulded body, in particular a lens element, comprising:
producing a pre-moulding in a moulding tool by injection moulding of a first plastics material,
producing at least one covering layer on the pre-moulding by injection moulding of a second plastics material,
wherein a pressure of from 250 bar to 800 bar is generated in the moulding tool during the production of the pre-moulding.

As has already been described, the object set out above can also be achieved by a pressure reduction, without a temperature reduction having to take place. Preferably, the pressure, that is to say the after-pressure, during the production of the pre-moulding can be in the range from 350 bar to 800 bar. Preferably, however, the pressure and the tool temperature can be reduced as compared with the optimum pressure or optimum tool temperature.

A further aspect of the invention is an optical moulded body, in particular a lens element, produced by a method as described above.

A further aspect is an optical moulded body, in particular produced by a method as described above, having a pre-moulding formed of a first plastics material and at least one covering layer formed of a second plastics material, wherein the first plastics material is formed of a different plastics material than the second plastics material.

As has already been described, by using different types of plastics material, the advantages of two different plastics materials can be utilised jointly.

According to a preferred embodiment of the optical moulded body, the layer thickness ratio between the pre-moulding and the covering layers can be from 60:40 to 70:30. Furthermore, the layer thickness of the upper covering layer can correspond substantially to the layer thickness of the lower covering layer.

Yet a further aspect of the invention is a use of an optical moulded body as described above in a lighting system as a lens with light-emitting diodes as the light source. Examples of lighting systems are headlamps, in particular motor vehicle headlamps, street lights, façade lighting, outside lighting, inside lighting, industrial lighting, etc.

The features of the methods and structural elements can be combined freely with one another. In particular, features of the description and/or of the dependent claims, even with complete or partial circumvention of features of the independent claims, can be independently inventive in isolation or when freely combined with one another.

There are a large number of possibilities for configuring and developing further the methods according to the invention for producing an optical moulded body, the optical moulded bodies according to the invention and the use according to the invention of the optical moulded body. In this connection, reference is made on the one hand to the patent claims that are subordinate to the independent patent claims and on the other hand to the description of exemplary embodiments in conjunction with the drawings, in which:

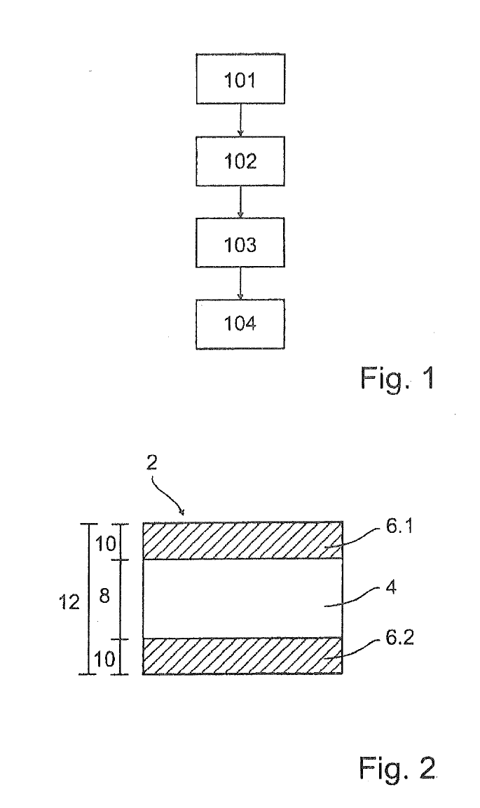

FIG. 1 shows a flow diagram of an exemplary embodiment of a method according to the invention for producing optical components from transparent thermoplastics by multi-layer injection moulding,

FIG. 2 shows a schematic view of an exemplary embodiment of an optical component produced by the method according to the invention,

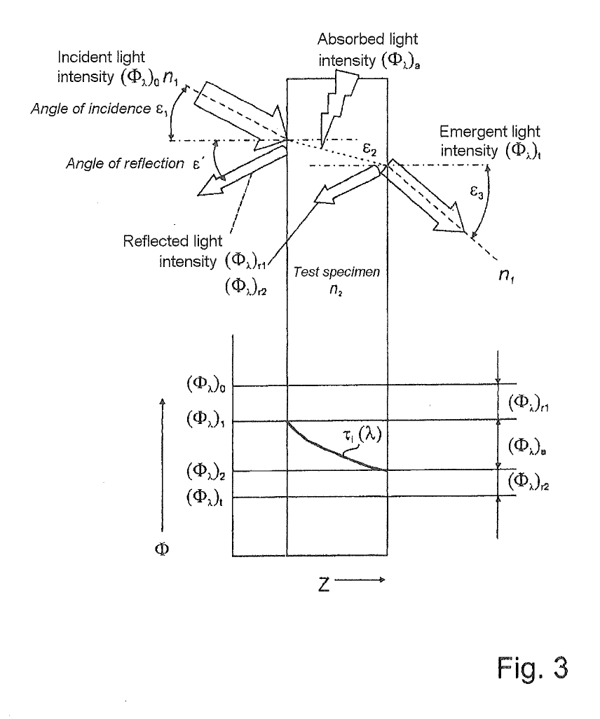

FIG. 3 shows a schematic view of the passage of light through an illumination lens,

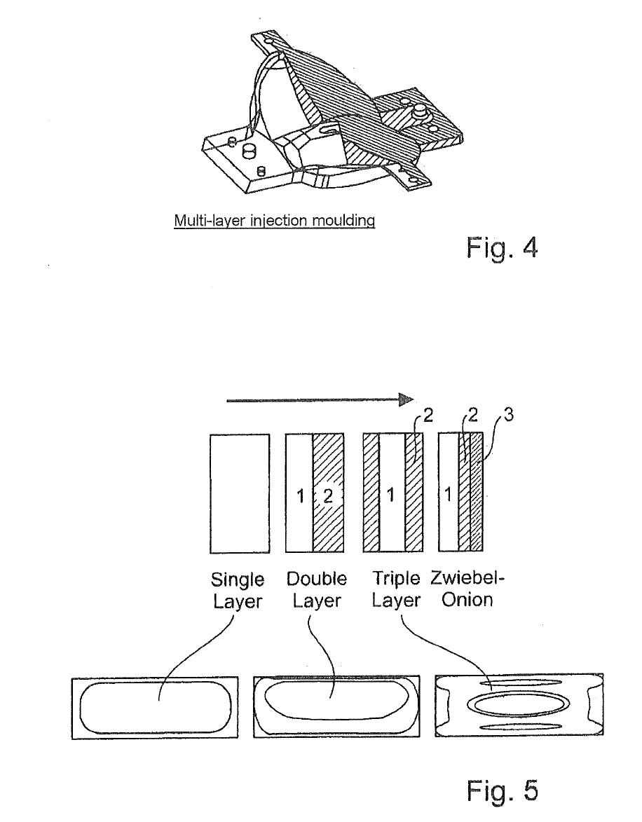

FIG. 4 shows a schematic view of an injection-moulded component produced by multi-layer injection moulding,

FIG. 5 shows a schematic view of optical components and their temperature profiles on cooling,

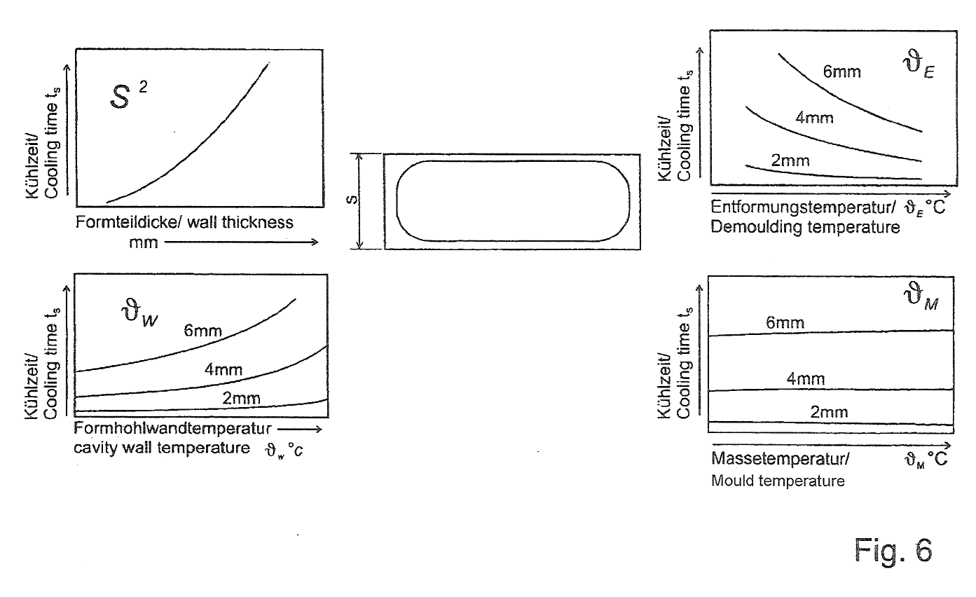

FIG. 6 shows exemplary diagrams relating to the cooling time of an injection-moulded component,

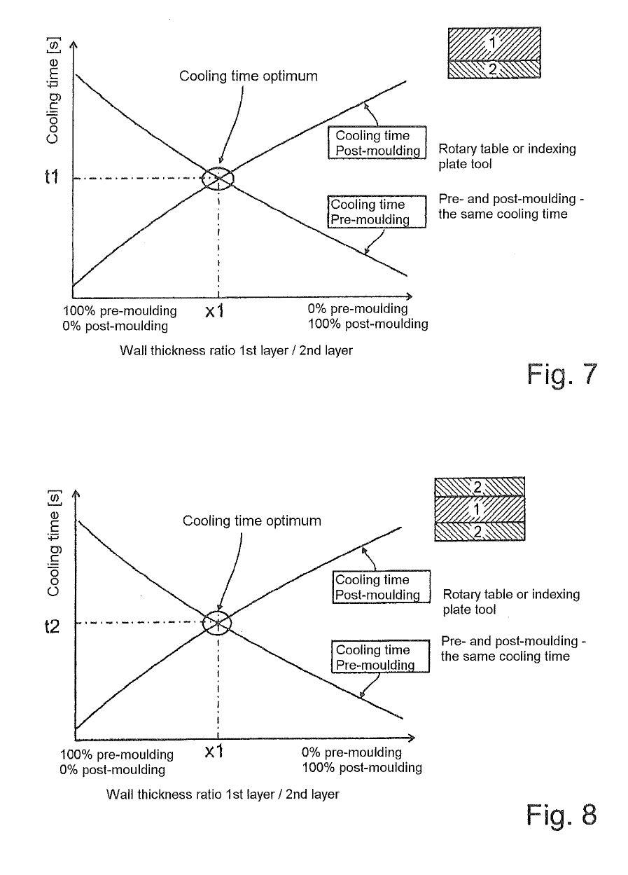

FIG. 7 shows a diagram with an exemplary qualitative cooling time optimum in the case of double-layer lenses of polycarbonate,

FIG. 8 shows a diagram with an exemplary qualitative cooling time optimum in the case of triple-layer lenses of polycarbonate,

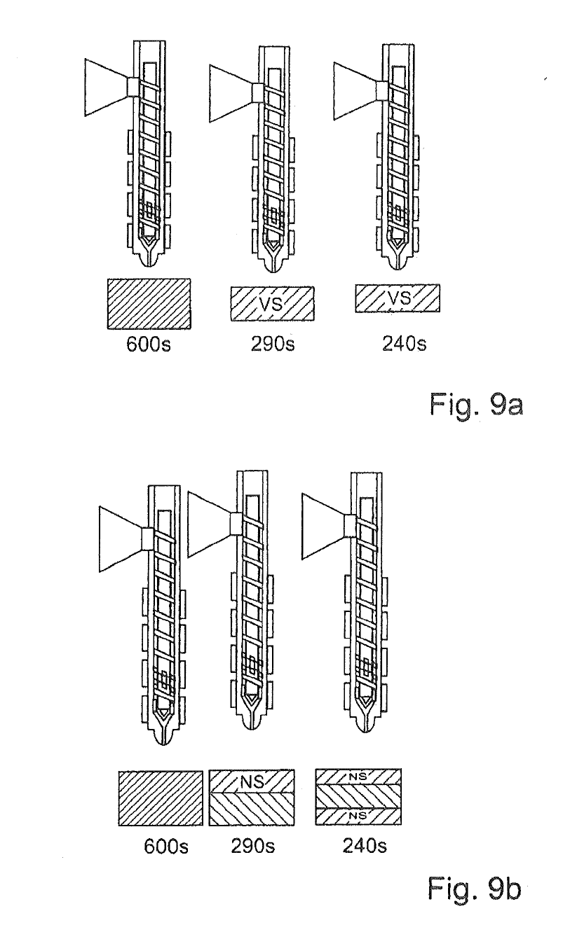

FIG. 9a shows a schematic view of the production on a 2-component injection moulding machine of a single-layer, double-layer and triple-layer lens,

FIG. 9b shows a further schematic view of the production on a 2-component injection moulding machine of a single-layer, double-layer and triple-layer lens,

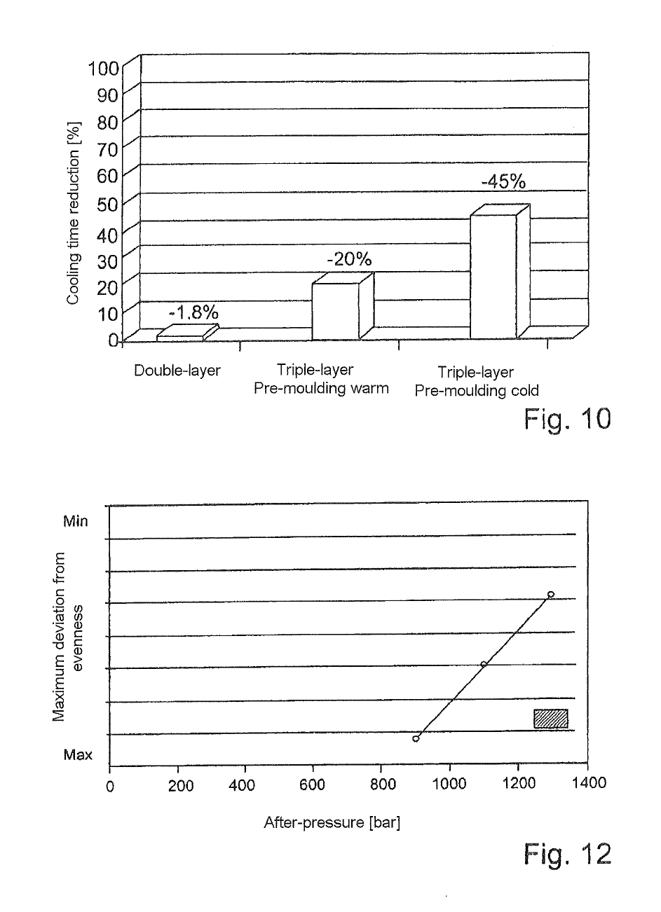

FIG. 10 shows a diagram with exemplary cooling time reductions of double-layer and triple-layer lenses in comparison with a single-layer lens,

FIG. 11 shows a schematic view of lens bodies (of Makrolon LED 2245) in single-layer, double-layer and triple-layer form,

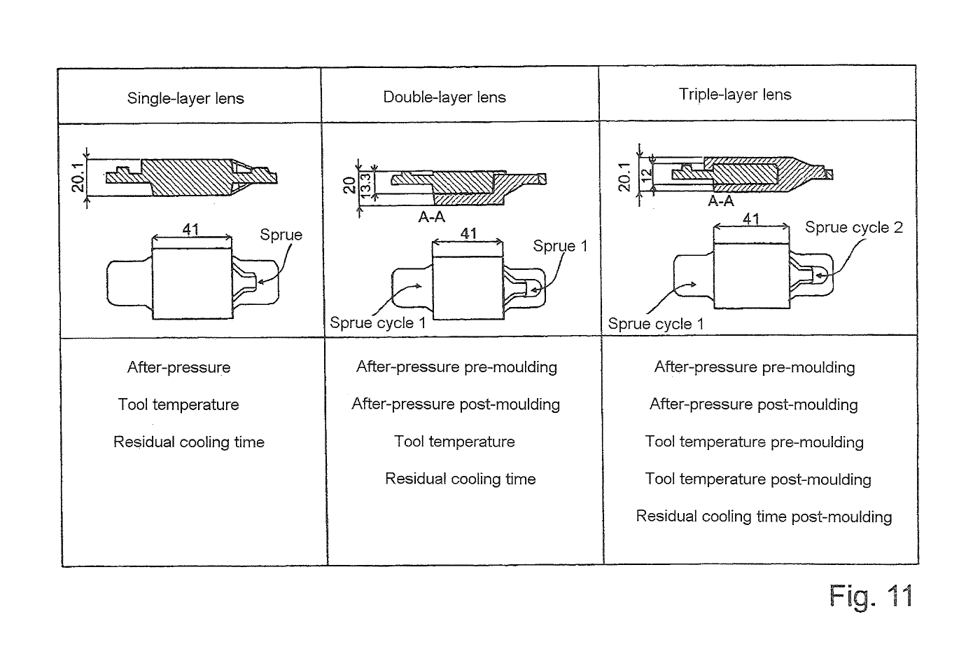

FIG. 12 shows a diagram with an exemplary profile of the maximum deviation from evenness in dependence on the after-pressure in a moulding tool,

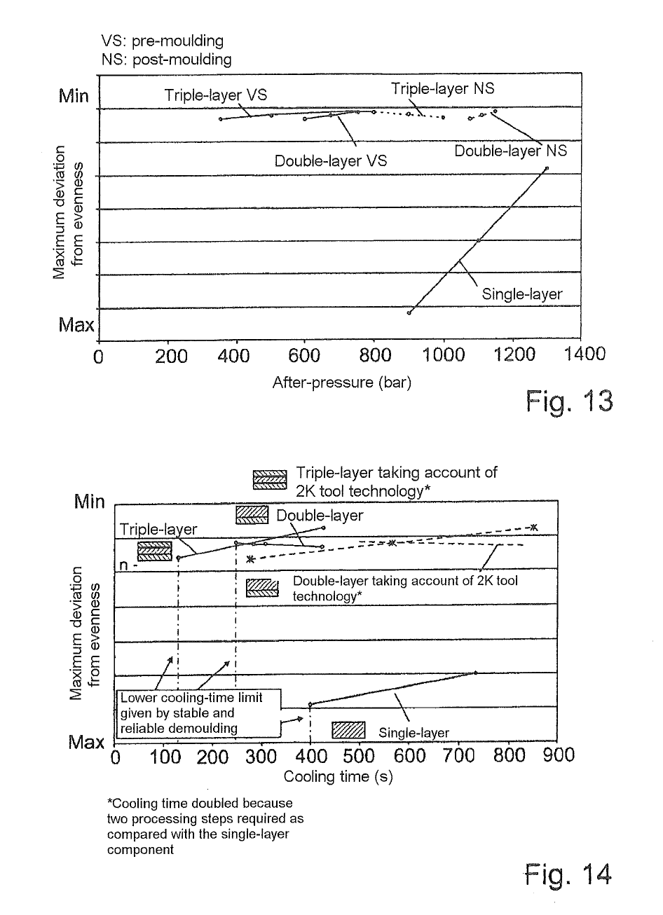

FIG. 13 shows a diagram with a further exemplary profile of the maximum deviation from evenness in dependence on the after-pressure in a moulding tool,

FIG. 14 shows a diagram with an exemplary profile of the maximum deviation from evenness in dependence on the cooling time,

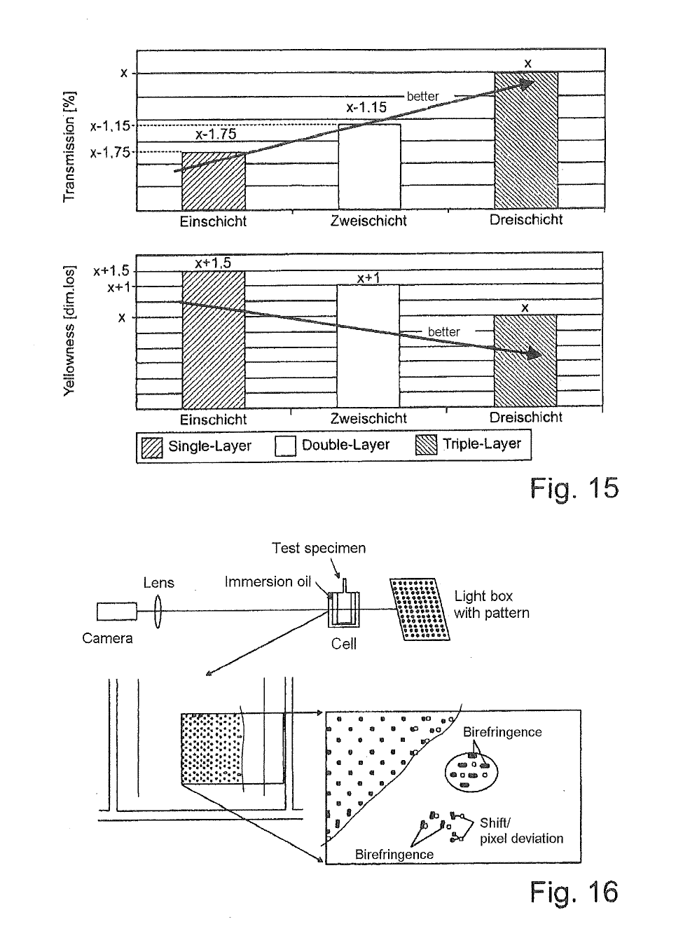

FIG. 15 shows a diagram with mean values of measured transmission and yellowness values of single-layer, double-layer and triple-layer lenses,

FIG. 16 shows a schematic view of an exemplary arrangement and principle for measuring the pixel shift,

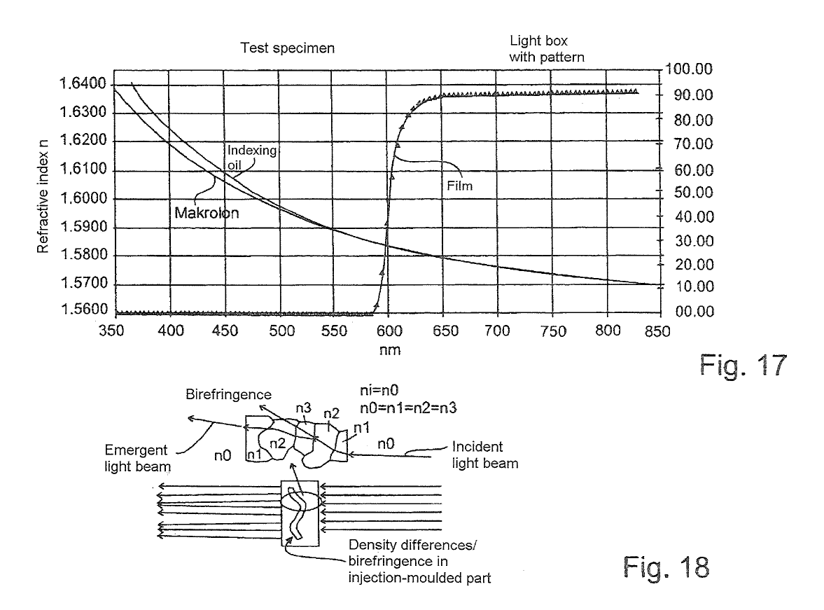

FIG. 17 shows a diagram with an exemplary profile of the test specimen, the oil and the film from the arrangement according to FIG. 16,

FIG. 18 shows a schematic view of an exemplary passage of light through an injection-moulded component,

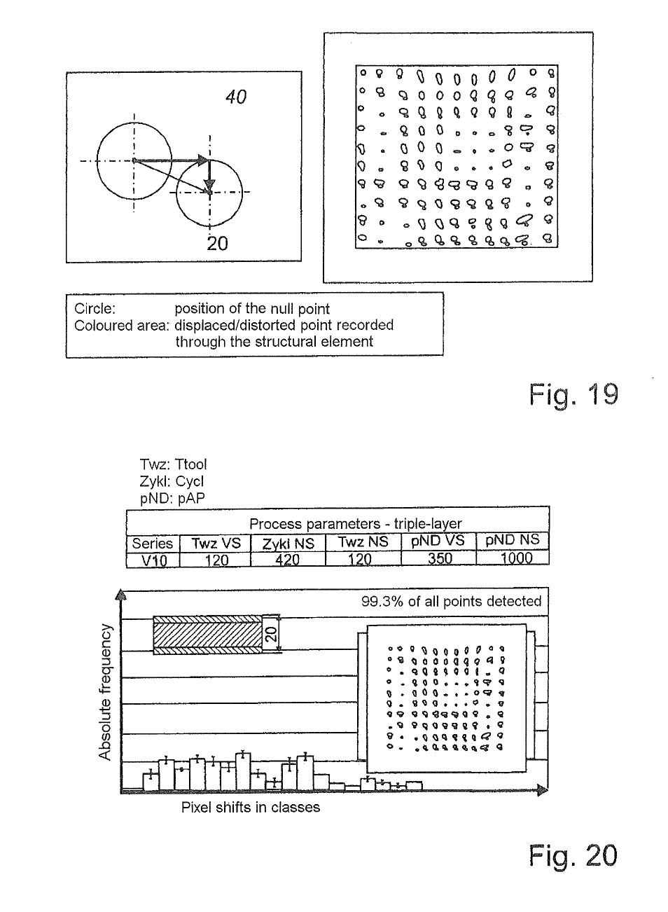

FIG. 19 shows a schematic view of an exemplary principle for measuring the pixel shift,

FIG. 20 shows an exemplary diagram in which the influence of processing on the “pixel shift” of a triple-layer lens is shown, wherein the tool temperature for producing the pre-moulding and the tool temperature for producing the covering layers are substantially the same,

FIG. 21 shows an exemplary diagram in which the influence of processing on the “pixel shift” of a single-layer lens is shown, wherein the tool temperature for producing the pre-moulding is lower than the tool temperature for producing the covering layers,

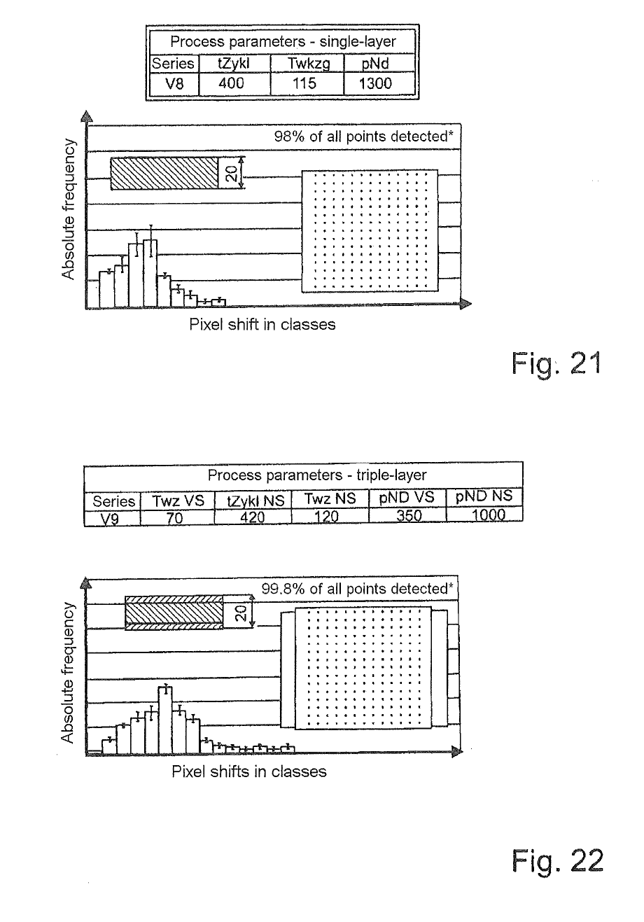

FIG. 22 shows an exemplary diagram in which the influence of processing on the “pixel shift” of a single-layer lens is shown,

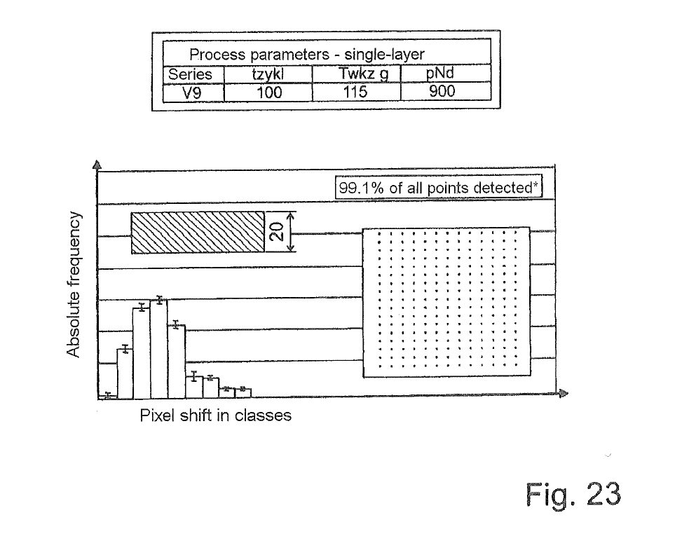

FIG. 23 shows an exemplary diagram in which the influence of processing on the “pixel shift” of a single-layer lens is shown,

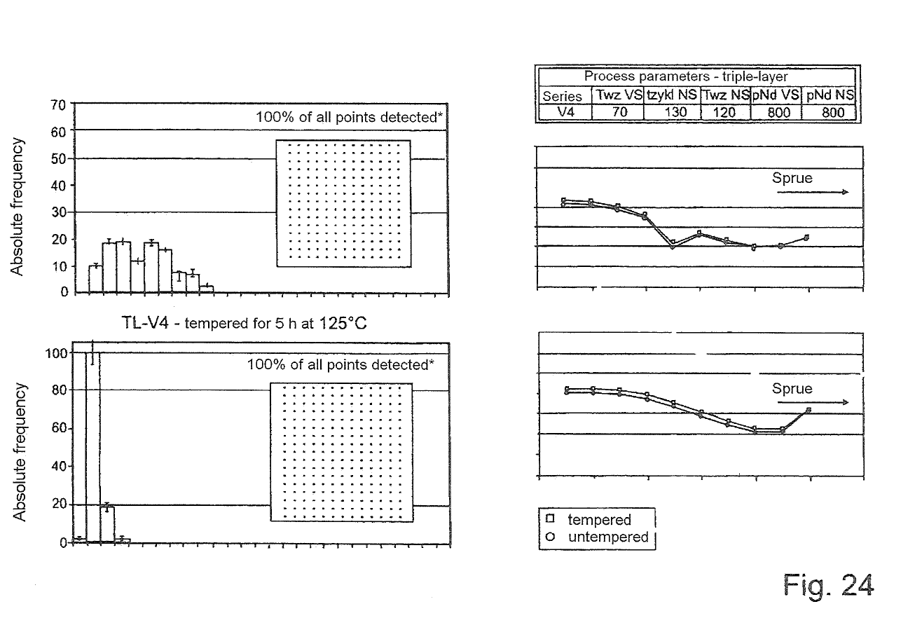

FIG. 24 shows an exemplary diagram in which the influence of tempering in the case of triple-layer lenses on the “pixel shift” is shown,

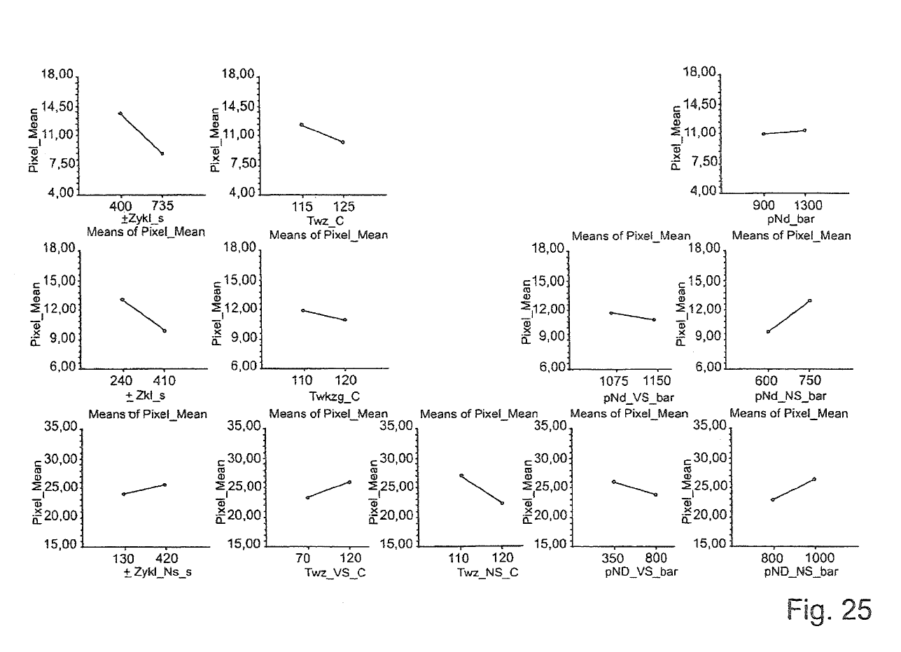

FIG. 25 shows a schematic view of exemplary pixel means,

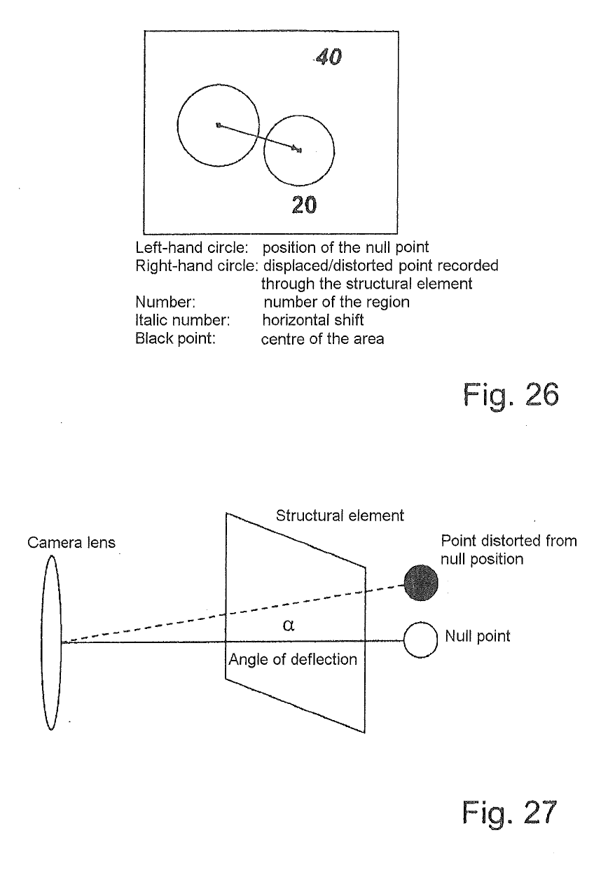

FIG. 26 shows a schematic view of an exemplary measurement of the quality of optical structural elements,

FIG. 27 shows a schematic view illustrating the angle of deflection, and

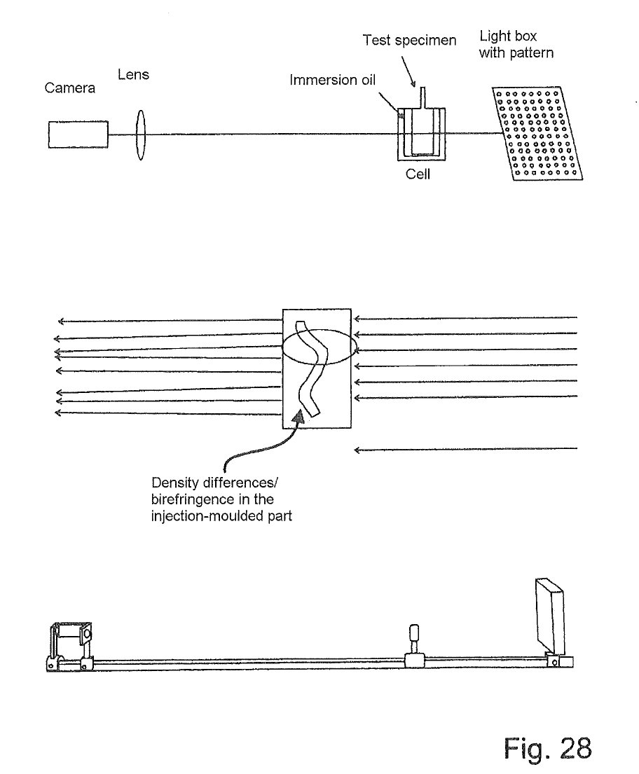

FIG. 28 shows a schematic view of an exemplary measuring arrangement for measuring the quality of optical structural elements.

FIG. 1 shows a flow diagram of an exemplary embodiment of a method according to the present invention. In a first step 101, the pre-moulding is formed in a moulding tool by injection moulding. There can be used as the material in particular a transparent plastics material. The pre-moulding is preferably produced from polycarbonate.

The temperature of the moulding tool, in particular the temperature of the cavities of the moulding tool, is set at a value that is from 30% to 60% below the temperature of the moulding tool that is set in the production of the at least one covering layer. Preferably, the temperature can be reduced by from 30% to 50%. In the case of polycarbonate in particular, a tool temperature of from 60° C. to 80° C., preferably approximately 70° C., can be set. It has been found, surprisingly, that, in particular in a temperature range of about 70° C., that is to say approximately from 65° C. to 75° C., internal stresses in the moulding can be reduced. At the same time, the production time can be reduced.

Alternatively or in addition to a reduction of the tool temperature, the pressure in the moulding tool during the production of the pre-moulding can be reduced as compared with an optimum pressure. For example, in the production of a pre-moulding of polycarbonate, a pressure of approximately from 250 bar to 800 bar, in particular from 350 bar to 800 bar, can be generated. In this manner too, internal stresses in the optical moulded body can be reduced.

The at least one covering layer, preferably both covering layers, are applied in a subsequent step 102 by injection moulding. Preferably, the same plastics material, in particular polycarbonate, as in the production of the pre-moulding can be used. A triple-layer lens can preferably be produced. An upper and a lower covering layer can be applied to the pre-moulding. When the application by injection moulding takes place simultaneously, the inner stresses in the moulding can be reduced further.

In particular, simultaneous injection moulding of the upper and lower covering layers can be carried out at an optimum tool temperature and/or an optimum pressure. An optimum tool temperature is to be understood as being in particular the temperature at which a layer or a moulded body with (almost) optimum optical properties can be produced. An optimum pressure is to be understood as being in particular the pressure at which a layer or a moulded body with (almost) optimum optical properties can be produced. In the case of polycarbonate, the optimum tool temperature is approximately 120° C. and the optimum pressure is from 800 bar to 1000 bar.

After a cooling phase, the optical moulded body can be removed from the cavity in a step 103. In addition, further processing steps can follow in a subsequent step 104.

FIG. 2 shows an exemplary embodiment of an optical moulded body 2 produced by the method described above. In particular, the moulded body 2 can be in transparent form. Preferably, the moulded body 2 can be a lens element 2. The optical moulded body 2 can preferably be used in lighting systems, for example as a lens element 2 for an LED motor vehicle headlamp.

The optical moulded body 2 shown comprises a pre-moulding 4, or a middle plastics layer 4. On the two broad surfaces of the pre-moulding 4 there are arranged an upper covering layer 6.1 and a lower covering layer 6.2.

The optical moulded body 2 has a thickness 12 of from 10 mm to 30 mm. According to the present exemplary embodiment, the thickness 8 of the pre-moulding 4 is greater than the thickness 10 of a covering layer 6.1, 6.2. As is apparent, the layer thickness 10 of the upper covering layer 6.1 in the present exemplary embodiment corresponds substantially to the layer thickness 10 of the lower covering layer 6.2. The ratio of the layer thickness 8 of the pre-moulding 4 to the layer thicknesses 10 of the covering layers 6.1, 6.2 can preferably be from 70:30 to 60:40.

For example, the layer thickness 12 of the optical moulded body can be 20 mm. The layer thickness 8 of the pre-moulding 4 can be approximately 12 mm and the layer thickness 10 of the covering layers 6.1, 6.2 can be approximately 4 mm

It will be appreciated that fundamentally more complex shapes can be produced and, in particular, the layer thickness profile of an element can vary. Furthermore, other plastics materials can also be used in addition to polycarbonate. It will be appreciated that the temperatures and/or the pressure of the moulding tool must be adapted in dependence on the plastics material used.

It should further be noted that, in the coming years, the field of LED technology will focus especially on non-imaging illumination, whereas developments in past years have been concentrated especially in the field of imaging optical systems. In contrast to imaging optics, the aim is not to produce an image of the light source. This specialist field of optics is concerned predominantly with the nature of the illumination of the target. A certain light distribution is produced with a given light source. The light distribution occurs by reflecting and transmitting materials, the surface of which reflects, refracts and also bends the incident light. These materials are referred to as optically passive. In combination with the light source, the optical system is formed. The optical design is necessary to increase the efficiency and for optimum light distribution.

In the field of non-imaging optics, and most particularly in illumination optics, there are new possibilities for plastics materials. Through the development of LED light sources, new areas can be opened up, for which there have not yet been any optical systems. Owing to the long lifetime and energy efficiency of LEDs as compared with conventional light sources, many branches of industry are very interested in LED lighting. In automotive construction, arguments in favour of the use of thermoplastics in illumination optics are the weight saving as compared with glass and the possibility of functional integration.

The new illumination optics today require highly complex, free-form, semi-refracting and semi-reflecting optics, which can be produced only with difficulty in glass. Furthermore, mass applications, which justify the use of injection moulding technology, are frequently appropriate in the field of illumination optics. The optical requirements are likewise high for many illumination applications, but are more easily convertible to plastics optics in direct comparison with imaging optics. Accordingly, imaging errors are of lesser importance, and the optical designer has more geometrical degrees of freedom in the design of his optics. Disadvantages in the optical properties of plastics (e.g. the dependence of the refractive index and geometry on temperature) can better be compensated for and/or tolerated as a result.

As described above, the optical plastics materials have great application potential in illumination optics. However, there are process-related challenges, which are discussed briefly below:

In order for many illumination optics to fulfil their functions, scattering and intensity losses as well as light ray deflections must be kept low. The fulfilment of function is in turn integrally achieved by the geometry of the functional surfaces (shape, waviness and roughness) and by the internal properties (transmission, absorption, dispersion, stresses, density distributions).

This means that the shaping accuracy of the optical functional surfaces at which light is coupled in and out must be very high. In relation to sink marks and form deviations, accuracies must be in the lower two-place mm range, and in the case of surface roughness even in the one-place mm range. On the other hand, this also means that the moulding volume must exhibit minimal internal stresses, impurities and anisotropic material properties in order that the optical properties are not adversely affected.

The described challenges clearly show the requirements that are made of the injection moulding process. On the one hand, the injection moulding process creates in the moulding a pressure, temperature and orientation distribution that differs locally and over time. This results in a more or less pronounced optical anisotropy through, for example, molecule orientations, density distributions and polarisation, which, as described above, can influence the optical behaviour. On the other hand, it must be ensured over the entire process chain that production is very clean and gentle, because any kind of impurities and defects, such as shrinkage holes, inclusions, flow lines, which adversely affect the optical properties, must be avoided.

Furthermore, added to these process-related requirements is the geometrical configuration resulting from the optical design. Very compact lens bodies with large wall thicknesses are often required.

Lenses, which form the focus here, can be referred to within the context of plastics technology as thick-walled. 10 mm, 20 mm and 30 mm are common wall thicknesses, which, moreover, can vary greatly according to the optical design and functional integrations. The thick regions of the moulding are slower to solidify than the thin regions, so that undesirable melt stagnation in thin regions and poorer pressure transmission, in particular in the after-pressure phase, into the thick-walled regions can occur. Uniform moulding filling and the required shaping precision of the optical faces are thus made more difficult. The large wall thicknesses additionally lead to very long cooling times. Depending on the wall thickness, they can be from 50 to 20 minutes and in some cases even longer. Owing to the associated long dwell times in the plastification unit of the injection moulding machine, the thermal load on the plastics materials, and accordingly the risk of material's being damaged, is greater than in other applications. Furthermore, continuous process management and control and the design of experiments are made more difficult by the long cooling times. Last but not least, the costs of such components are adversely affected by the long cooling and cycle times.

In summary, it can be seen that, for the optics under consideration here, major process-related challenges arise from the very high precision and cleanliness required by the optical design, in conjunction with the thick-walled geometries, which are very disadvantageous for plastics processing technology. Important components of the process chain for producing such parts are today still in the development and pilot stage, in particular those which achieve the required illumination quality with as short as possible a cycle time.

Multi-layer injection moulding moves away from the conventional method of injection moulding or injection compression moulding and attempts to produce an optical component by layer-wise production. In layer-wise production, the individual layers are thinner than the total wall thickness, so that a reduction of the cooling time is possible because the sum of the cooling times of the individual layers is shorter than the cooling time in the single-layer method. Initial theoretical assessments predict that multi-layer injection moulding has great potential for reducing cycle times. The “Autolight” project conducted by BMBF (under the sponsorship of the VDI) has the object in a sub-project of substantially improving simulation techniques for predicting the most advantageous layer division in complex free-form optics. In particular also by quantitative cooling time predictions combined with the inclusion of quality predictions in the simulation.

Furthermore, the question arises of whether there are differences in the achievement of specific optical and geometric quality features between optical components produced by single-layer, double-layer or triple-layer injection moulding.

Detailed practical research on this subject is currently being carried out in a study at Bayer MaterialScience. The core of this research is to demonstrate on an optical component the fundamental differences of multi-layer injection moulding in comparison with standard injection moulding. To that end, comparative tests are carried out on an optical geometry produced by single-layer, double-layer and triple-layer injection moulding.

The spectrum of requirements that are made of optical components is diverse. The requirements can in turn be weighted differently depending on the particular field of application of the illumination optics. The requirements are fulfilled, as mentioned above, by the combination of material properties and geometry. Knowledge of the influence and limits of the production process is very important, because a very considerable influence can be exerted thereby on the later properties.

Geometric requirements can be contour, surface, roughness, radius of curvature, dimensions, angles and tolerances. Optical requirements can be refractive index/dispersion, degree of reflection, transmission, absorption, scatter, inherent colour, birefringence. Visual requirements can be gloss, shrinkage holes, inclusions, surface defects (haze, inclusions), dirt and flow lines. Light-related requirements can be light source, illumination, light distribution, colour, legal requirements. Environmental requirements can be temperature stability, moisture, chemical resistance, yellowing, modulus of elasticity, constructive integration, mechanics and tolerances. Economic requirements can be cycle time, quantity, fixed costs, tool and machine outlay, rejects and tolerances.

LED light has no or only a small UV and IR component and permits novel optics. The advantages of the injection moulding process in surface shaping and form variety can be utilised fully in illumination and sensor optics. Mass applications, in which shaping by the injection moulding process begins to pay off, are in illumination and sensor optics. The qualities which can be achieved with transparent plastics materials are in agreement with the requirements of precise illumination optics and sensors.

The potential and challenges of transparent plastics materials for illumination optics:

There is potential because complex, free-form, semi-refracting and semi-reflecting optics can only be mass-produced with difficulty in glass.

Challenges are the illumination characteristics, such as the geometry of the functional surface (shape, waviness and roughness) and the internal properties (transmission, absorption, dispersion, stresses), low scattering and intensity losses, as well as light ray deflections, therefore high shaping accuracy of the optical functional surfaces injection moulding process produces optically anisotropic material joint (density, stresses, orientations, polarisation), high requirements in terms of purity, that is to say no impurities and defects such as shrinkage holes, inclusions, flow lines, compact lens bodies with large wall thicknesses (10 mm, 20 mm and 30 mm). Uniform moulding filling and pressure transmission is thereby made more difficult. In addition, the large wall thicknesses lead to very long cooling times.

Basic considerations regarding the cooling time (see FIG. 6):

$${t}_{k} = \frac{{s}^{2}}{{π}^{2} {a}_{2 ff}} ln ( \frac{8}{{π}^{2}} Θ ) , \\ Θ = ( \frac{{\partial }_{M} - {\overline{\partial }}_{W}}{{\partial }_{E} - {\overline{\partial }}_{W}} ) .$$

Initial theoretical considerations show that multi-layer injection moulding has great potential for reducing the cycle time. Comprehensive validation of the simulation of the cooling time for multi-layer systems and complex free-form optics in the BMBF “Autolight” project, in particular with inclusion of the prediction of achievable qualities.

Example: Production on a 2-component injection moulding machine of a single-layer, double-layer and triple-layer lens (see FIG. 9a, 9b). As is apparent in particular, the cycle time in the case of a triple-layer lens can be reduced by over 50% as compared with a single-layer lens.

Total lens thickness S=20 mm
Melt temperature JM=280° C.
Tool temperature pre-moulding VS=120° C.
Tool temperature post-moulding NS=120° C.
Heat transfer coefficient a=2000 W/m2K
Demoulding temp. in moulding middle JE=150° C.
Every 600 s two single-layer lenses
Every 290 s one double-layer lens
Every 580 s two double-layer lenses
Every 240 s one triple-layer lens
Every 480 s two triple-layer lenses

Non-validated, theoretical results: Only the cooling time reduction alone was considered here. Time components which arise in the case of multi-layer injection moulding as a result of additional intermediate opening of the tool and injection are not taken into account here.

In an inhomogeneous medium, the refractive index is not constant (see FIG. 18). Gradients of the change in refractive index (direction of the most pronounced change). At this interface, the conventional law of refraction applies to the passing light ray. The light ray is refracted in the direction of the gradient. If these changes are added together, a non-linear light path and a non-uniform point shift are generally obtained. If the refractive index and also its gradient field in an anisotropic medium for two polarisation directions are different, a point division occurs. If the medium is anisotropic and inhomogeneous, the two effects are added together. The case is present in the injection-moulded part.

The tool temperature of the pre-moulding (TWZ VS) has a major influence in the composite as a whole on the pixel shift (see FIGS. 20 and 21).

Lower pressures with better surface shaping can be achieved in the multi-layer components. In the case of polycarbonate, very positive influence on transmission and the yellowness index in the triple-layer system. Influence of the production method and of processing can be demonstrated.

Further embodiments relate to a measuring apparatus and a method of measuring the quality of optical structural elements in transmission.

In order to determine the distortion of the structural element, the ray deflection is studied in dependence on the position in the structural element. The displacement of the points from their intended position is determined, when they are recorded through the structural element. To that end, the following arrangement has been developed. Using an observation unit, in particular an IDS μEye CMOS camera, an object unit, in particular a point matrix, is recorded through the structural element via a 200 mm lens. The point matrix consists of a transparent film with black points 1 mm in size at intervals of 3.5 mm, mounted on a light box.

In order to exclude surface effects, such as curvature, scratches and sprue edges, of the structural element, the structural element, according to an advantageous embodiment of the invention, is measured in a cell surrounded by immersion oil having the same refractive power as the injection-moulded part. The cell consists of a metal frame with guides for optimum positioning of the structural element, and two borosilicate windows, which are arranged parallel to one another. In order precisely to match the refractive index of the immersion oil to the PC structural element, measurement is carried out in a wavelength range of from 650 to 700 nm.

In order to compensate for any errors of the cell, a null image with the cell and immersion oil is first prepared. Three null images are preferably acquired, in which the oil is stirred in order to minimise inhomogeneities of the oil. This is necessary because the immersion oil is not homogeneous.

According to an advantageous embodiment of the invention there is provided an evaluation unit which is connected with the observation unit via a data link, the evaluation unit being configured to quantify the distortions in a spatially resolved manner. This unit and its mode of operation are described in the following purely by way of example:

### Software Evaluation:

In the circle detection in the image, all pixels having a grey value less than 65 (image of the injection-moulded part grey value less than 75) are chosen as a region. This region is divided into individual connected regions. Regions that have a smaller area than 900 pixels (structural element 150 pixels) are not taken into consideration.

For the position of the null-image points, the means of three null images, which were prepared prior to each partial measurement series, are formed, in order to detect a shift of the measuring arrangement.

In the structural element images, the distorted circles are then extracted as regions and their positions are determined. In an iteration process, the closest null circles are assigned to the distorted circle images. This is carried out in steps of 10-20 pixels so that no mis-assignment takes place. In the images of some tests, additional conditions for the null assignment must be fulfilled in order to avoid incorrect evaulations. For example, in some series, in the left-hand region of the image, the point images must always be located to the right of the null images.

The distance of the points to the null point is always the shortest diagonal.

The assigned regions are coloured differently depending on the horizontal or vertical distance to the null circles.
10 pixels forest green
20 pixels green
30 pixels khaki
40 pixels goldenrod
50 pixels Indian red
70 pixels red
90 pixels red
100 pixels red

The deviation of the circle position from the null position is a measure of the distortion of the structural element, which is caused by a non-ordered structure of the polymer crystals (birefringence, refractive index gradient).

The shifts of all imaged points are given out as a colour-coded region image with superposed null regions. The upper black number above the region indicates the pixel shift. The white number is the number of the region.

The angular displacement of the position in the structural element is given by the distance of the structural element to the camera lens, the scale and the pixel shift.

$$α = arctan ( \frac{pixel shift * scale}{camera lens - point matrix} )$$

A deviation of 10 pixels gives an angular deviation of 0.005° or 0.000087 RAD.

### Camera Settings:

The illumination is a fluorescent lamp which is operated at 500 Hz, in order to avoid variations in brightness. The images are recorded with an integration time of 109 ms and a frame rate of 5.8 fps. The images have a size of 2560×1920 pixels at a pixel resolution of 24.4 μm/pixel (image field: 46.83×62.44 mm)

Distance camera—cell: 2000 mm
Distance cell—point matrix: 800 mm

Data are imported into Excel and a histogram is prepared with a class width of 5 pixels.

The repetitive error of the measuring method is ±2 pixels.

1-15. (canceled)

16. A method for producing an optical moulded body, in particular a lens element, the method comprising:
producing a pre-moulding in a moulding tool by injection moulding of a first plastics material, and
producing at least one covering layer on the pre-moulding by injection moulding of a second plastics material,
wherein
the temperature of the moulding tool for producing the pre-moulding is from 30% to 60% lower than the temperature of the moulding tool for producing the at least one covering layer.

17. The method according to claim 16, wherein an upper covering layer and a lower covering layer are applied to the pre-moulding by simultaneous injection moulding of the covering layers.

18. The method according to claim 16, wherein
the first plastics material is formed of the same plastics material as the second plastics material, or
the first plastics material is formed of a different plastics material than the second plastics material.

19. The method according to claim 16, wherein the plastics material is a transparent thermoplastic plastic, in particular polycarbonate.

20. The method according to claim 19, wherein
the temperature of the moulding tool for producing the pre-moulding is from 50° C. to 100° C., preferably from 60° C. to 80° C., particularly preferably approximately 70°, and/or
the temperature of the moulding tool for producing the at least one covering layer is from 90° C. to 130° C., preferably approximately 120° C.

21. The method according to claim 16, wherein a pressure of from 250 bar to 800 bar, preferably from 350 bar to 800 bar, particularly preferably from 350 bar to 500 bar, is generated in the moulding tool during the production of the pre-moulding.

22. The method according to claim 16, wherein the layer thickness ratio between the pre-moulding and the covering layers is from 60:40 to 70:30.

23. The method according to claim 17, wherein the layer thickness of the upper covering layer corresponds substantially to the layer thickness of the lower covering layer.

24. The method according to claim 16, wherein an optical moulded body having a thickness of at least 10 mm is produced.

25. The method according to claim 16, characterised in that, after the injection operation for producing the at least one covering layer, the temperature of the moulding tool is reduced.

26. The method for producing an optical moulded body, in particular a lens element, comprising:
producing a pre-moulding in a moulding tool by injection moulding of a first thermoplastic plastic, and
producing at least one covering layer on the pre-moulding by injection moulding of a second thermoplastic plastic,
wherein
a pressure of from 250 bar to 800 bar is generated in the moulding tool during the production of the pre-moulding.

27. Optical moulded body, in particular produced by a method according to claim 16, having a pre-moulding formed of a first plastics material and at least one covering layer formed of a second plastics material, wherein the first plastics material is formed of a different plastics material than the second plastics material.

28. Optical moulded body according to claim 27, wherein the layer thickness ratio between the pre-moulding and the covering layers is from 60:40 to 70:30.

29. Optical moulded body according to claim 27, wherein the layer thickness of the upper covering layer corresponds substantially to the layer thickness of the lower covering layer.

30. Use of the optical moulded body according to claim 27 in a lighting system as a lens with light-emitting diodes as the light source.
